(19) United States
(12) Patent Application Publication
(10) Pub. No.: US 2023/0180794 A1
(43) Pub. Date: Jun. 15, 2023

(54) METHODS AND SYSTEMS FOR HYDROPONICALLY SPROUTED CEREAL GRAINS AS A MECHANISM FOR LOWERING ENTERIC METHANE EMISSION AND IMPROVING RUMINANT FEED EFFICIENCY AND PERFORMANCE

(71) Applicant: HydroGreen, Inc., Langley (CA)

(72) Inventors: Shawn Jenkins, Colton, SD (US); Emmalee Slack, Sioux Falls, SD (US)

(73) Assignee: HydroGreen, Inc., Langley (CA)

(21) Appl. No.: 17/551,664

(22) Filed: Dec. 15, 2021

(51) Int. Cl. A23K 20/105; A23K 50/10

(52) U.S. Cl. CPC A23K 20/105; A23K 50/10

(57) ABSTRACT

Processes and methods for hydroponically sprouted cereal grains disclose as a mechanism for lowering enteric methane emission and improving ruminant feed efficiency and ruminant performance by administering to a ruminant a feed ration having at least one feed component comprising one or more hydroponically sprouted cereal grains.

### FIELD OF THE INVENTION

The present invention relates to an enteric methane mitigation method and system using hydroponically sprouted cereal grains. More particularly, but not exclusively, the present invention relates to methods and systems for hydroponically sprouted cereal grains as a mechanism for lowering enteric methane emission and improving ruminant feed efficiency and performance.

### BACKGROUND

Reductions in enteric fermentation methane emissions for ruminants has been identified as an area of opportunity for the agriculture sector. The U.S. agricultural industry is responsible for approximately 10% of the total U.S. greenhouse gas (GHG) emissions with 41% of this being attributable to enteric fermentation and manure management in livestock systems (IPCC, 2014). While the direct influence of livestock systems to overall GHG emissions is relatively low, enteric fermentation and manure management in livestock systems has been estimated to be directly responsible for 38% of the total U.S. methane emission (EPA, 2020). Therefore, what is needed are processes and systems for hydroponically sprouted cereal grains as a mechanism for lowering enteric methane emission and improving ruminant feed efficiency and performance. What is further needed are processes and systems for hydroponically sprouted cereal grains as a mechanism for increasing metabolic energy in ruminants. What is additionally needed are processes and systems for hydroponically sprouted cereal grains as a mechanism for increasing milk production and improving milk composition in milk producing ruminants.

### SUMMARY

Therefore, it is a primary object, feature, or advantage of the present disclosure to improve over the state of the art.

It is a further object, feature, or advantage of the present disclosure to decrease enteric methane emission with a feed component having one or more hydroponically sprouted cereal grains.

It is a still further object, feature, or advantage of the present disclosure to increase feed efficiency for ruminants with a feed component having one or more hydroponically sprouted cereal grains.

Another object, feature, or advantage of the present disclosure is to increase milk production and improve milk composition for ruminants with a feed component having one or more hydroponically sprouted cereal grains.

Yet another object, feature, or advantage of the present disclosure is to increase metabolic energy in ruminants with a feed component having one or more hydroponically sprouted cereal grains.

A further object, feature, or advantage of the present disclosure is to increase rates of glycolysis within the rumen with a feed component having one or more hydroponically sprouted cereal grains.

In one aspect of the present disclosure a method for hydroponically sprouted cereal grains as a mechanism for lowering enteric methane emission and improving ruminant feed efficiency and performance is disclosed. The method includes steps, such as, for example, administering to a ruminant a feed ration having at least one feed component comprising one or more hydroponically sprouted cereal grains for reducing enteric methane emission. The method can also include steps, such as, for example, increasing concentration of hexoses within the rumen with the feed ration, increasing rates of glycolysis within the rumen with the feed ration, reducing dihydrogen concentrations and lowering the acetate to propionate volatile fatty acid ratio within the rumen with the feed ration, and increasing metabolic energy in the ruminant with the feed ration. In accordance with at least one exemplary aspect, the one or more inputs for methanogenic archaea are reduced thereby reducing methanogenesis and the methane reduction measurements are on an energy corrected milk basis. In still another exemplary aspect, the method includes steps, such as, increasing milk production and improving milk composition in the ruminant with the feed ration and increasing efficiency of the feed ration having the at least one feed component comprising the one or more hydroponically sprouted cereal grains.

In another aspect of the present disclosure a method for managing methane emission in a ruminant is disclosed. The method includes steps, such as, for example, hydroponically sprouting one or more cereal grains for at least one feed component for ruminants and feeding the ruminant a feed ration having the at least one feed component comprising the one or more hydroponically sprouted cereal grains for reducing enteric methane production. The method includes steps, such as, for example, increasing concentration of hexoses within the rumen with the feed ratio, increasing rates of glycolysis within the rumen with the feed ration, reducing dihydrogen concentrations and lowering the acetate to propionate volatile fatty acid ratio within the rumen with the feed ration, and increasing metabolic energy in the ruminant with the feed ration. In accordance with at least one exemplary aspect, the one or more inputs for methanogenic archaea are reduced thereby reducing methanogenesis. In still another exemplary aspect, the steps include, for example, increasing milk production and improving milk composition in the ruminant with the feed ration. In another exemplary aspect, the method includes, for example, increasing efficiency of the feed ration having the at least one feed component comprising the one or more hydroponically sprouted cereal grains.

In another aspect of the present disclosure a system for hydroponically sprouted cereal grains as a mechanism for lowering enteric methane emission and improving ruminant feed efficiency and ruminant performance is disclosed. The system includes, for example, a grower for hydroponically sprouting one or more cereal grains for growing at least one feed component for ruminants and a feed ration having the at least one feed component comprising the one or more hydroponically sprouted cereal grains for reducing enteric methane production in ruminants. In one aspect, the feed ration having the at least one feed component comprising the one or more hydroponically sprouted cereal grains increases metabolic energy in the ruminant with the feed ration. In another aspect, the feed ration having the at least one feed component comprising the one or more hydroponically sprouted cereal grains increases milk production and milk composition in the ruminant. In still another aspect, the feed ration having the at least one feed component comprising the one or more hydroponically sprouted cereal grains increases efficiency of the feed ration.

One or more of these and/or other objects, features, or advantages of the present disclosure will become apparent from the specification and claims that follow. No single aspect need provide each and every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein.

FIG. 1 is a schematic illustrating carbohydrate fermentation in the rumen.

FIG. 2 is an illustration of the interaction between phytohormones and dry matter in accordance with an illustrative aspect of the disclosure.

FIG. 3A is a pictorial representation of animal feed grown under hypoxic conditions.

FIG. 3B is a pictorial representation of animal feed grown under aerobic conditions.

FIG. 4 is chart illustrating adenosine triphosphate (ATP) production under different environmental conditions.

FIG. 5 is an illustration of the interaction between phytohormones in accordance with an illustrative aspect of the disclosure.

FIG. 6 is an illustration of the hydrolysis reaction of cellulose and xylan.

FIG. 7 is an illustration depicting the hydrolysis of maltose into two glucose molecules.

FIG. 8 is an illustration depicting Adenosine Triphosphate production.

FIG. 9 is a chart illustrating results for hydroponically sprouted test rations in accordance with an exemplary aspect of the present disclosure.

FIG. 10 is a chart illustrating results for control treatment test rations in accordance with an exemplary aspect of the present disclosure.

FIG. 11 is a plot illustrating the distribution of methane concentration by pen from a milking parlor data collection setting in accordance with an exemplary aspect of the present disclosure.

FIG. 12 is an illustration of the grower system in accordance with an illustrative aspect of the disclosure.

FIG. 13 is a side perspective view of a portion of the seed bed of the growing system in accordance with an illustrative aspect of the disclosure.

FIG. 14 is another side perspective view of a portion of the grower system illustrating a seed bed thereof.

FIG. 15 is a side perspective view of a portion of the grower system illustrating another seed bed thereof.

FIG. 16 is an end perspective view of a portion of the grower system further illustrating the seed bed shown in FIG. 15.

FIG. 17 is a side perspective view of a portion of the grower system illustrating another seed bed thereof.

FIG. 18 is a block diagram illustrating another perspective of the grower system.

FIG. 19 is a flowchart illustrating a process for reducing enteric methane emission.

FIG. 20 is a flowchart illustrating another process for reducing enteric methane emission.

### BRIEF DEACTION OF THE TABLES

Illustrated aspects of the disclosure are described in detail below with reference to attached Tables, which are incorporated by reference herein and where:

Table 1 provides methane concentration analysis estimates by sampling location; and

Table 2 provides nutrient composition on a percentage basis of treatment and control rations.

### DETAILED DESCRIPTION

Methane has significantly different properties in the atmosphere compared to carbon dioxide. Compared to the most well noted GHG on a per kilogram basis, CH₄ has a comparative environmental impact roughly 25 times greater than CO₂ over a 100-year time (The Global Carbon Project, 2019). Along with greatly increased heat retention atmospheric properties, CH₄ negatively impacts air quality by enabling ground-level ozone formation (Lynch et al., 2021). With the relative impact of CH₄ considered, agricultural emissions of the potent GHG will need to fall approximately 25%-50% from 2010 emissions by 2050 to stabilize global temperatures below 1.5° C. above current day levels (IPCC, 2014). Without intervention, current CH₄ emissions from the agricultural sector will alone be directly responsible for a 1.5° C. global increase surpassing current targets (Clark et al., 2020).

To address the rising concern of agriculturally related methane emission, multiple CH₄ mitigation strategies have been suggested. The inclusion of 3-nitroxypropanol (3-NOP) has gained the most recent recognition which reduces CH₄ emissions in dairy cattle by 20% to 30% (Lopes et al., 2016; Melgar et al., 2020a, 2020b, 2021). Studies investigating the influence of 3-NOP on dairy cattle suggest a slight negative influence on milk yield, feed efficiency, coupled with a slight positive effect on milk composition (Melgar et al., 2021). Plant based essential oils and feed products have also been proposed to serve as potential CH₄ mitigation strategies with recent interest given to Asparagopsis taxiformis (seaweed) (Kinley et al., 2020). Recent studies have reported enteric reductions of up to 80% in beef, however transportation considerations demanded by the ocean product to preserve bioactive compounds and reductions in dry matter intake warrant further investigation and present major hurdles for commercial application (Roque et al., 2021; Vin et al., 2020).

Ruminants are highly valued in human food systems for their inherent ability to extract metabolic energy from fiber rich feedstuffs. Within the rumen, microorganisms such as bacteria, fungi and protozoa hydrolyze fibryolytic compounds produce volatile fatty acids (VFA) such as acetate, propionate, and butyrate along with formic acid, hydrogen, and carbon dioxide. With hydrogen and carbon dioxide production, methanogenic archaea in the rumen reduce carbon dioxide with hydrogen gas to produce methane. Methanogenic archaea enable reductions in hydrogen and carbon dioxide concentrations within the rumen yet provide no direct value to the metabolic requirements of the host organisms. As a whole, CH₄ production within the rumen represents a total energy loss of 2%-12% to the atmosphere (Johnson and Johnson, 1995).

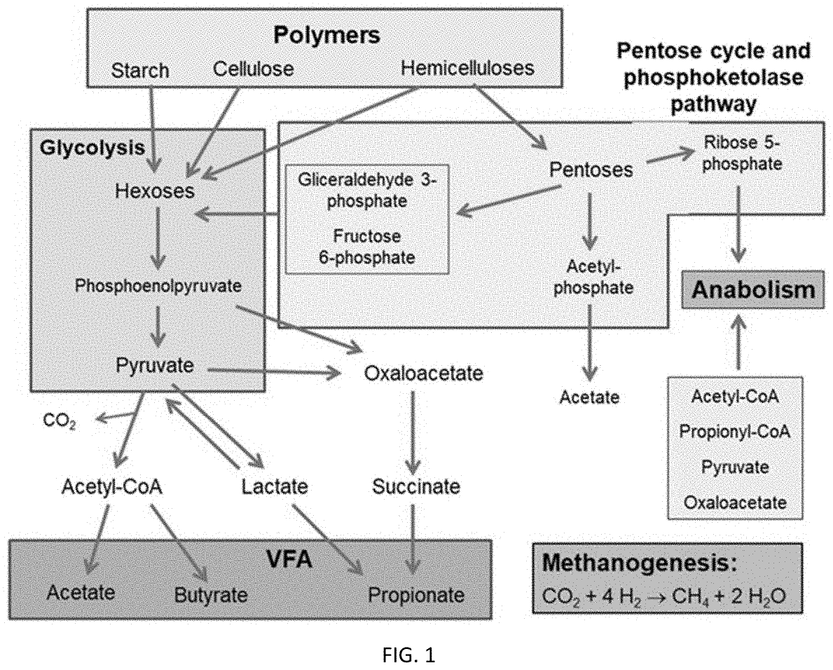

As an alternative to enzymatic inhibitors such as 3-NOP, controlling the VFA profile has been suggested as a mechanism to reduce enteric CH₄ mitigation (Ungerfeld 2020). Plant structural carbohydrates such as xyloses, arabinose, and lignans are metabolized in the pentose cycle through transketolase cleavage (Russell and Wallace, 1997). Through the pentose cycle acetate and ribose 5-phosphate are produced (Voet and Voet, 1995). Favoring glycolysis through increased supplementation of hexoses supports increased production of propionate through lactate lowering acetyl-CoA and carbon dioxide pathways (FIG. 1).

The processes and methods of the present disclosure reduce enteric CH₄ production within ruminants. The processes and methods of the present disclosure provide hydroponically sprouted cereal grains as a sustainable and scalable solution to mitigate enteric methane emissions from ruminants. The processes and methods of the present disclosure increase relative concentration of hexoses and thereby rates of glycolysis through inclusion of hydroponically sprouted grains to reduce dihydrogen concentrations within the rumen. With reduced dihydrogen concentrations, inputs for methanogenic archaea are reduced thereby reducing the rate of methanogenesis. Hydrolysis reactions external to the rumen, e.g., enzymatic hydrolysis of hemicelluloses during germination, improve efficiency of energy utilization, reduce hydrogen dioxide formation, and reduce enteric methane production.

Endogenous enzymes produced during controlled hydroponic germination of seeds can be used for enhancing the nutrient digestion capabilities of animal feedstuffs including feed concentrates, forages, and mineral supplements. Leveraging metabolic processes common to higher plants during germination and seedling development, the grower system enables the transformation of complex polysaccharides including starch and cellulose, complex proteins, and triglycerides into their reduced monosaccharide, amino acid, and fatty acid precursors, respectively. When enzymes are incorporated into a high starch diet, such as by increasing the amount of enzymes within a plant, and allowed time to act before animal digestion there is an overall impact on nutrient digestibility. In a six-day period, approximately 75% of the starting starch concentration and 90% of the starting protein concentration may be hydrolyzed into simpler precursors within developing cereal grains.

The plant or seed may refer to any plant from the kingdom Plantae or angiosperms including flowering plants, cereal grains, grain legumes, grasses, roots and tuber crops, vegetable crops, fruit plants, pulses, medicinal crops, aromatic crops, beverage plants, sugars and starches, spices, oil plants, fiber crops, latex crops, food crops, feed crops, plantation crops or forage crops.

Cereal grains may include rice (Oryza sativa), wheat (Triticum), maize (Zea mays), rye (Secale cereale), oat (Avena sativa), barley, (Hordeum vulgare), sorghum (Sorghum bicolor), pearl millet (Pennisetum glacucum), finger millet (Eleusine coracana), barnyard millet (Echinochloa frumentacea), Italian millet (Setaria italica), kodo millet (Paspalum scrobiculatum), common millet (Panicum millaceum).

Pulses may include black gram, kalai, or urd (Vigna mungo var, radiatus), chickling vetch (Lathyrus sativus), chickpea (Cicer arietinum), cowpea (Vigna sinensis), green gram mung (Vigna radiatus), horse gram (Macrotyloma uniflorum), lentil (Lens esculenta), moth bean (Phaseolus aconitifolia), peas (Pisum sativum) pigeon pea (Cajanas cajan, Cajanus indicus), philipesara (Phaseolus trilobus), soybean (Glycine max).

Oilseeds may include black mustard (Brassica nigra), castor (Ricinus communis), coconut (Cocus nucifera), peanut (Arachis hypgaea), Indian mustard (Brassica juncea), toria (Napus), niger (Guizotia abyssinica), linseed (Linum usitatissumun), safflower (Carthamus tinctorious), sesame (Seasmum indicum), sunflower (Helianthus annus), white mustard (Brassica alba), oil palm (Elaeis guniensis). Fiber crops may include sun hemp (Crotalaria juncea), jute (Corchorus), cotton (Gossypium), mesta (Hibiscus), or tobacco (Nicotiana).

Sugar and starch crops may include potato (Solanum tberosum), sweet potato (Ipomea batatus), tapioca (Manihunt esculenta), sugarcane (Saccharum officinarum), sugar beet (Beta vulgaris). Spices may include black pepper (Piper nigrum) betel vine (Piper betle), cardamom (Elettaria cardamomum), garlic (Allium sativum), ginger (Zingiber officinale), onion (Allium cepa), red pepper or chilies (Capsicum annum), or turmeric (Curcuma longa). Forage grasses may include buffel grass or anjan (Cenchrus ciliaris), dallis grass (Paspalum dilatatum), dinanath grass (Pennisetum), guniea grass (Panicum maximum), marvel grass (Dicanthium annulatum), napier or elephant grass (Pennisetum purpureum), pangola grass (Digitaria decumbens), para grass (Brachiaria mutica), sudan grass (Sorghum sudanense), teosinte (Echlaena mexicana), or blue Panicum (Panicum antidotale). Forage legume crops may include berseem or egyptian clover (Trifolium alexandrinum), centrosema (Centrosema pubescens), gaur or cluster bean (Cyamopsis tetragonoloba), Alfalfa or lucerne (Medicago sativa), sirato (Macroptlium atropurpureum), velvet bean (Mucuna cochinchinensis).

Plantation crops may include banana (Musa paradisiaca), areca palm (Areca catechu), arrowroot (Maranta arundinacea), cacao (Theobroma cacao), coconut (Cocos nucifera), Coffee (Coffea arabica), tea (Camellia theasinesis). Vegetable crops may include ash gourd (Beniacasa cerifera), bitter gourd (Momordica charantia), bottle gourd (Lagenaria leucantha), brinjal (Solanum melongena), broad bean (Vicia faba), cabbage (Brassica), carrot (Daucus carota), cauliflower (Brassica), colocasia (Colocasia esulenta), cucumber (Cucumis sativus), double bean (Phaseolus lunatus), elephant ear or edible arum (Colocasia antiquorum), elephant foot or yam (Amorphophallus campanulatus), french bean (Phaseolus vulgaris), knol khol (Brassica), yam (Dioscorea) lettuce (Lactuca sativa), musk melon (Cucumis melo), pointed gourd or parwal (Trichosanthes diora), pumpkin (Cucrbita), radish (Raphanus sativus), bhendi (Abelmoschus esculentus), ridge gourd (Luffa acutangular), spinach (Spinacia oleracea), snake gourd (Trichosanthes anguina), tomato (Lycoperscium esculentus), turnip (Brassica), or watermelon (Citrullus vulgaris).

Medicinal crops may include aloe (Aloe vera), ashwagnatha (Withania somnifera), belladonna (Atropa belladonna), bishop's weed (Ammi visnaga), bringaraj (Eclipta alba.), cinchona (Cinchona sp.) Coleus (Coleus forskholli), Dioscorea, (Dioscorea), glory lily (Gloriosa superba), ipecae (Cephaelis ipecauanha), long pepper (Poper longum), prim rose (Oenothera lamarekiana), roselle (Hibiscus sabdariffa), sarpagandha (Rauvalfia serpentine) senna (Cassia angustifolia), sweet flag (Acorus calamus), or valeriana (Valeriana wallaichii).

Aromatic crops may include ambrette (Abelmoschus moschatus), celery (Apium graveolens), citronella (Cymbopogon winterianus), geranium (Pelargonium graveolens.), Jasmine (Jasminum grantiflorum), khus (Vetiveria zizanoids), lavender (Lavendula sp.) lemon grass (Cymbopogon flexuosus), mint, palmarosa (cymbopogon martini), patchouli (Pogostemon cablin), sandal wood (Santalum album), sacred basil (Ocimum sanctum), or Tuberose (Polianthus tuberosa). Food crops are harvested for human consumption and feed crops are harvested for livestock consumption. Forage crops may include crops that animals feed on directly or that may be cut and fed to livestock.

Nutrient digestibility is the amount of nutrients absorbed by the individual or animal and is generally calculated as the amount of nutrients consumed minus the amount of nutrients retained in the feces. The incorporate of enzymes into dairy and beef rations has yielded mixed results and has primarily been focused on amylase in cattle. The incorporation of amylase into dairy and beef rations has been shown to increase milk to feed conversions by twelve percent when 15,000 KNUs were supplied in a starch rich ration. In beef cattle, the addition of 12,000 KNUs of exogenouse amylase improved the daily rate of gain by eight percent. The direct influence of amylase of milk yield and components is mixed with increases in milk and milk components reported by few authors Consistently across trials the addition of amylase has been reported to improve nutrient digestibility and feed use efficiency. The use of enzymes produced during the germination process of cereal grains has long been used in application for the malting industry, the process of leveraging enzymes produced during the optimized hydroponic germination of seeds has yet to be implemented in the feed industry to improve the digestion of feedstuffs. A process of leveraging enzymes naturally produced during the optimized hydroponic germination of seeds is needed.

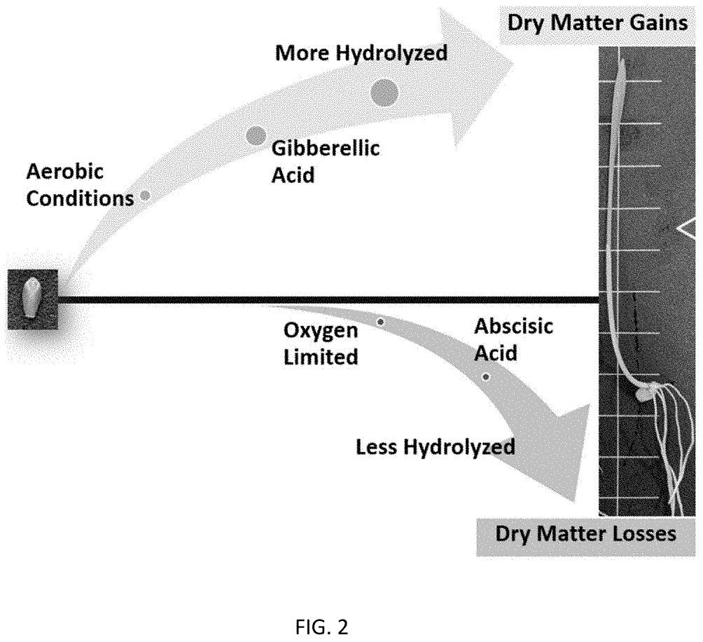

Plant growth and the production of enzymes are greatly affected by the environment. Most plant problems, such as decreased nutrient digestibility, are caused by environmental stresses due to environmental conditions. Environmental factors such as water, humidity, nutrition, light, temperature, level of oxygen present can affect a plants growth and development as shown in FIGS. 2-4.

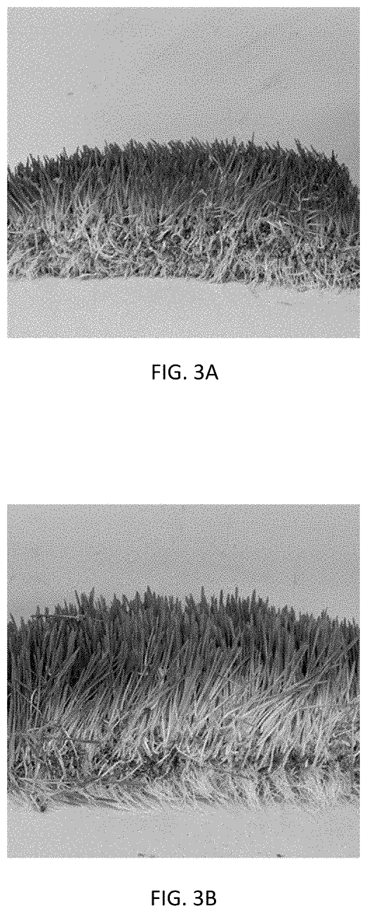

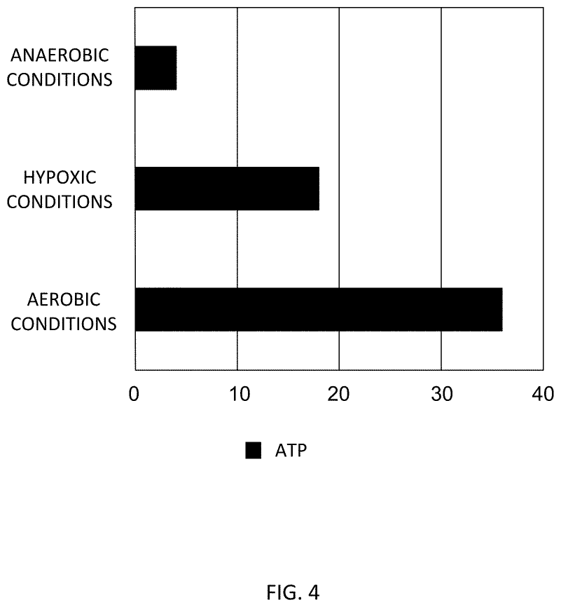

Oxygen is a necessary component in many plant processes included respiration and nutrient movement from the soil into the roots. The amount of oxygen can influence the efficiency of respiration. Oxygen moved passively into the plant through diffusion. Plants growing in anaerobic conditions, where the uptake or disappearance of oxygen is greater than its production by photosynthesis or diffusion by physical transport from the surrounding environment. Anaerobic conditions can cause nutrient deficiencies or toxicities within the plant, root or plant death, or reduced growth of the plant. Anaerobic conditions may be caused by a decrease in the amount of oxygen in the air, such as growing a plant or seed in a room without air or oxygen circulation. However, oxygen bound in compounds such as nitrate (NO₃), nitrite (NO₂), and sulfites (SO₃) may still be present in the environment. Waterlogging, where excess water in the root zone of the plant or in the soil inhibits gaseous exchange with the air can also cause anaerobic conditions. Hypoxic conditions arise when there is insufficient oxygen in a plant's environment and the plant must adapt its growth and metabolism accordingly. Excessive watering or waterlogged soil can cause hypoxic conditions. When anaerobic or hypoxic conditions persist, the microbial, fungal and plant activities quickly use up any remaining oxygen. The plant becomes stressed due to the lack of nutrient uptake by the roots, the plant stomata begin to close, and photosynthesis is reduced. A prolonged period of oxygen deficiency can lead to reduced yields, root dieback, plant death, or greater susceptibility to disease and pests as shown in FIG. 3A. Under aerobic conditions plant growth can thrive, as shown in FIG. 3B. Aerobic conditions are when there is enough oxygen molecules or compounds and energy present to carry out oxidative reactions including nutrient cycling, as shown in FIG. 4.

Light is a necessary component for plant growth and the increase in the production of enzymes, sugars and starches that increase nutrient digestibility. The more light a plant receives, the greater its capacity for producing food and energy via photosynthesis. The energy can be used to produce or increase the expression of enzymes that increase nutrient digestibility. Temperature influences most plant processes, including photosynthesis, transpiration, respiration, germination, and flowering. As temperature increases up to a certain point, photosynthesis, transpiration, and respiration increase. When the temperature is too low or exceeds the maximum point photosynthesis, transpiration, and respiration decrease. When combined with day-length, temperature also affects the change from vegetative to reproductive growth. The temperature for germination may vary by plant species. Generally, cool-season crops (e.g., spinach, radish, and lettuce) germinate between 55° to 65° F., while warm-season crops (e.g., tomato, petunia, and lobelia) germinate between at 65° to 75° F. Low temperatures reduce energy use and increase simple sugar storage whereas adverse temperatures, however, cause stunted growth and poor-quality plants.

Water and humidity play an important role in increasing nutrient digestibility. Most growing plants contain ninety percent water, Water is the primary component of photosynthesis and respiration. Water is also responsible for the turgor pressure needed to maintain cell shape and ensure cell growth. Water acts as a solvent for minerals and carbohydrates moving through the plant, acts as a medium for some plant biochemical reactions, increases enzyme production and expression, and cools the plant as it evaporates during transpiration. Water can regulate stomatal opening and closing thereby controlling transpiration and photosynthesis and is a source of pressure for moving roots through a growing medium such as soil. Humidity is the ratio of water vapor in the air to the amount of water the air can hold at the current temperature and pressure. Warm air can hold more water vapor than cold air. Water vapor moves from an area of high humidity to an area of low humidity. Water vapor moves faster if there is a greater difference between the area of high humidity and the area of low humidity. When the plant's stoma open, water vapor rushes outside the plant into the surrounding air. An area of high humidity forms around the stoma and reduces the difference in humidity between the air spaces inside the plant and the air adjacent to the plant, slowing down transpiration. If air blows the area of high humidity around the plant away, transpiration increases.

Plant nutrition plays an important role in increasing nutrient digestibility. Plant nutrition is the plant's need for and use of basic chemical elements. Plants need at least 17 chemical elements for normal growth. Carbon, hydrogen, and oxygen can be found in the air or in water. The macronutrients, nitrogen, potassium, magnesium, calcium, phosphorus, and sulfur are used in relatively large amounts by plants. Nitrogen plays a fundamental role in energy metabolism, protein synthesis, and is directly related to plant growth. It is indispensable for photosynthesis activity and chlorophyll formation. It promotes cellular multiplication. A nitrogen deficiency results in a loss of vigor and color. Growth becomes slow and leaves fall off, starting at the bottom of the plant. Calcium attaches to the walls of plant tissues, stabilizing the cell wall and favoring cell wall formation. Calcium aids in cell growth, cell development and improves plant vigor by activating the formation of roots and their growth. Calcium stabilizes and regulates several different processes. Magnesium is essential for photosynthesis and promotes the absorption and transportation of phosphorus. It contributes to the storage of sugars within the plant. Magnesium performs the function of an enzyme activator. Sulfur is necessary for performing photosynthesis and intervenes in protein synthesis and tissue formation.

The plant micronutrients or trace elements, iron, zinc, molybdenum, manganese, boron, copper, cobalt, and chlorine, are used by the plant in smaller amounts. Macronutrients and micronutrients can be dissolved by water and then absorbed by a plant's roots. A shortage in any of them leads to deficiencies, with different adverse effects on the plant's general state, depending upon which nutrient is missing and to what degree. Fertilization may affect nutrient digestibility. Fertilization is when nutrients are added to the environment around a plant. Fertilizers can be added to the water or a plant's growing surface, such as soil. Additional micronutrients and macronutrients can be added to the plant by the grower system 10.

Plant growth can be split into four growing stages: imbibition, plateau, germination, and seedling. Imbibition is the uptake of water by a dry seed. As the seed intakes the water, the seed expands, enzymes and food supplies become hydrated. The enzymes become active, and the seed increases its metabolic activity. During imbibition the relative humidity is high and may range from 90% to 98% relative humidity. The temperature may range from 76° F. to 82° F. or 22° C. to 28° C. Air movement is minimal. The imbibition may last 18 to 24 hours. The plateau stage is where water uptake increases very little. The plateau stage is associated with hormone metabolism such as abscisic acid and gibberellic acid (GA) synthesis or deactivation. During the plateau stage humidity and temperature may be lower than the imbibition stage. Relative humidity may range from 70% to 90% and the temperature may range from 72° F. to 77° F. or 22° C. to 26° C. Air movement may still be minimal. The plateau stage may last 18-24 hours. Germination is the sprouting of a seed, spore, or other reproductive body. The absorption of water, temperature, oxygen availability and light exposure may operate in initiating the process. During germination, the relative humidity may be lower than the imbibition and plateau stage. Relative humidity may range from 60% to 70%. The temperature may be the same as the plateau stage and range from 72° F. to 77° F. or 22° C. to 26° C. Air movement may be moderate. Germination may last 24 to 48 hours. The last phase is the seedling or plant development phase where the plant's roots develop and spread, nutrients are absorbed fueling the plants rapid growth. The seedling stage may last until the plant matures. The seedling stage may also be broken down into additional phases: seedling, budding, flowering and ripening. The relative humidity may be lowest at this stage and range from 40% to 60%. The temperature may also be the lowest at this stage and range from 68° F. to 72° F. or 20° C. to 22° C. Air movement is high. The seedling phase can range from 72 hours or until the plant reaches maturity. The specific control of temperature encourages maximum enzyme hydrolysis throughout development while potentially discouraging the cellular division near the onset of photosynthesis. Temperatures near the cardinal range of seeds is believed to support maximum enzyme hydrolysis approximately through the first 120 hours. Reducing temperatures below the cardinal value at 120 hours is believed to reduce metabolic activity in tissue readily exposed to the environment while having reduced influence on the seed within the cellulosic material layer.

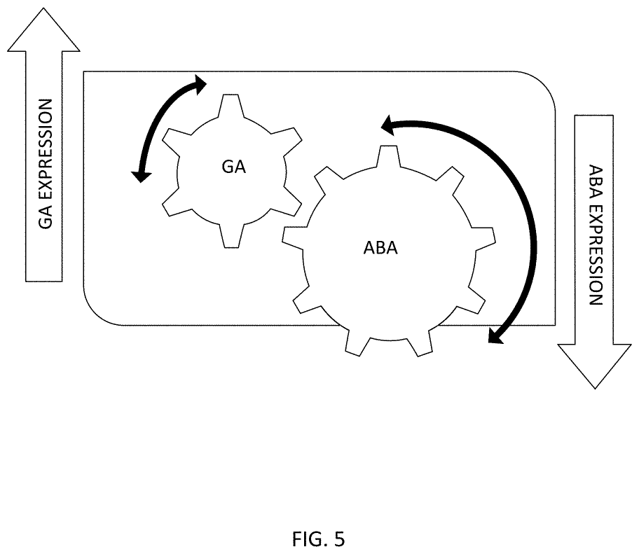

Phytohormones, such as abscisic acid (ABA), GA and ethylene (ET) regulate seed dormancy and seed germination as well as balance or dictate enzyme production. The ratio of ABA and GA regulates seed dormancy. When levels of ABA are high, stomatal closure, stress signaling and delay in cell division is triggered down regulating metabolic and enzyme activity. High ABA/GA ratios favor dormancy, whereas low ABA/GA ratios result in seed germination. The increase in GA is necessary for seed germination to occur, as GA expression increases, ABA expression decreases, as shown in FIG. 5. GA triggers cell division, stem elongation and root development. Enzyme expression is closely linked to metabolic needs during germination. As the plant becomes metabolically active shortly after imbibition, GA is released from the seed embryo signaling the release of a wide profile of enzymes from within the seed including from the aleurone layer surrounding the polysaccharide and protein rich endosperm of the seed. During germination, GA translocates to and interacts with the aleurone layer, thereby releasing or synthesizing hydrolytic enzymes, included α-amylase. The term “amylase’ means an enzyme that hydrolyzes 1,4-alpha-glucosidic linkages in oligosaccharides and polysaccharides, including the following classes of enzymes: alpha-amylase, beta-amylase, glucoamylase, and alpha-glucosidase.

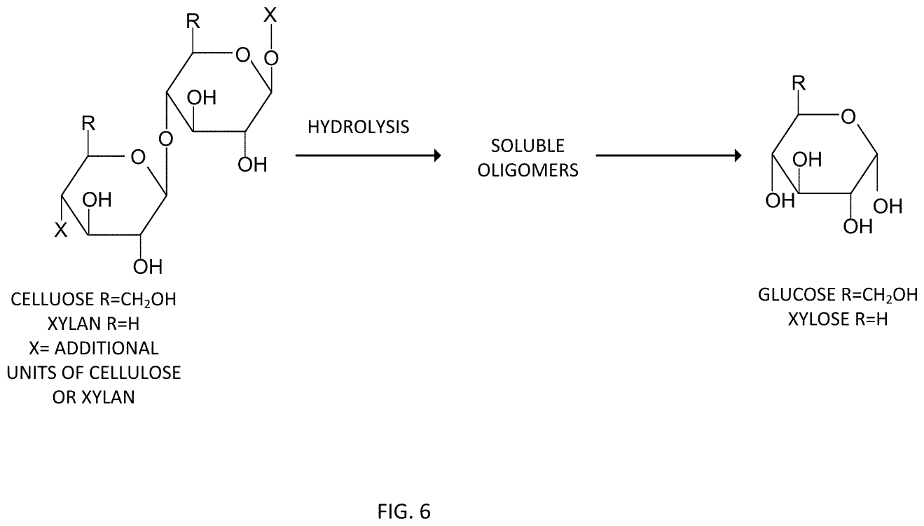

Hydrolytic enzymes are some of the most energy efficient enzymes. The hydrolytic enzymes, such as 1,3;1,4-β-glucanase (β-glucanase), α-amylase and β-amylase, are released. The term “beta-glucosidase’ means a beta-D-glucoside glucohydrolase that catalyzes the hydrolysis of terminal non-reducing beta D-glucose residues with the release of beta-D-glucose. Once the hydrolytic enzymes are released, they facilitate the hydrolysis of complex storage molecules including cell wall polysaccharides, proteases, storage proteins, and starchy energy reserves that are essential for germination, providing sugars that drive the root growth, into their simpler monomer subunits. Hydrolysis of the storage molecules is one of the primary energy sources of plants. The hydrolytic enzymes break the polymers into dimers or soluble oligomers and then into monomers by water splitting the chemical bonds, as shown in FIG. 6.

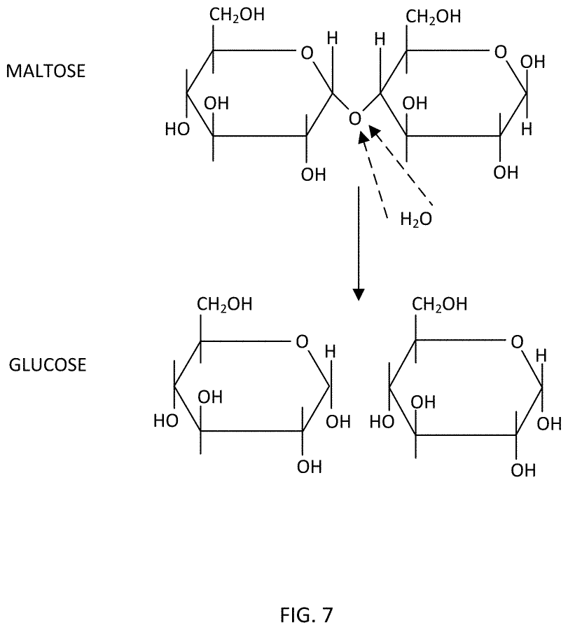

β-glucanase may hydrolyze 1,3;1,4-β-glucan, a predominant cell wall polysaccharide. The α-amylase cleaves internal amylose and amylopectin residues. The β-amylase exo-hydrolase liberates maltose and glucose from the starch molecules as shown in FIG. 7. These reduced nutrient forms are commonly then transported back to the embryo where glycolysis and the cellular respiration pathway uses glucose to produce ATP needed for energy intensive cellular division and biosynthesis reactions. As the metabolic needs of the juvenile plant increases, the release of GA from the seed embryo and the release of enzymes from the aleurone layer likewise increases. Enzyme activity within the juvenile plant peaks at the onset of efficient photosynthesis. At this point, the total metabolic demands of the plant are not able to be met by photosynthesis and a large amount of storage molecules must be hydrolyzed to glucose for glycolysis and ATP generation.

Most mammals have a hard time digesting dietary fibers including cellulose. Cellulose polysaccharides are the prominent biomass of the primary cell wall, followed by hemicellulose and pectin. Cellulosic material is any material containing cellulose. The secondary cell wall, produced after the cell has stopped growing, also contains polysaccharides and is strengthened by polymeric lignin covalently cross-linked to hemicellulose. Cellulose is a homopolymer of anhydrocellobiose and is a linear beta-(1-4)-D-glucan. Hemicellulose can include a variety of compounds, such as, Xylans, Xyloglucans, arabinoxylans, and mannans in complex branched structures with a spectrum of Substituents. Cellulose, although polymorphous, is primarily found as a insoluble crystalline matrix of parallel glucan chains. Hemicellulose usually hydrogen bonds to cellulose as well as other hemicelluloses, stabilizing the cell wall matrix. Cellulolytic enzymes or cellulase mean one or more enxymes that hydrolyze a celluloise material. The enzymes may include endoglucanase(s), cellobiohydrolase(s), beta-glucosidase(s), or combinations thereof. The enzymes break the cellulosic material down into cellodextrins or completely into glucose. Hemmicellulolytic enzyme or hemicullase are one or more enzymes that hydrolyze a hemicellulosic material forming furfural or arabinose and xylose.

Beta-xylosidase, or beta-D-xyloside xylohydrolase, catalyzes the exo-hydrolysis of short beta (1->4)-xylooligosaccharides to remove successive d-xylose residues from non-reducing termini and may hydrolyze xylobiose. Beta-xylosidase engage in the final breakdown of hemicelluloses. The term “xylanase” means a 1,4-beta D-xylan-Xylohydrolase that catalyzes the endohydrolysis of 1,4-beta-D-Xylosidic linkages in Xylans. The term “endoglucanase” means an endo-1,4-(1,3:1,4)-beta-D-glucan 4-glucanohydrolase that catalyzes endohydrolysis of 1,4-beta-Dglycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or Xyloglucans, and other plant material containing cellulosic components.

Lignin is another primary component of the cell wall. Lignin is a class of complex polymers that form key structural materials in support tissues, such as the primary cell wall, in most plants. The lignols that crosslink to form lignins are of three main types, all derived from phenylpropane: coniferyl alcohol (4-hydroxy-3-methoxyphenylpropane), sinapyl alcohol (3,5-dimethoxy-4-hydroxyphenylpropane), and paracoumaryl alcohol (4-hydroxyphenylpropane. Lignin fills the spaces in the cell wall between cellulose, hemicellulose, and pectin components. It can covalently crosslink to hemicellulose mechanically strengthening the cell wall. Ligninolytic enzymes are enzymes that hydrolyze lignin polymers. The ligninolytic enzymes include lignin peroxidases, manganese peroxidases, laccases and feruloyl esterases, and other enzymes described in the art known to depolymerize or otherwise break lignin polymers. Also included are enzymes capable of hydrolyzing bonds formed between hemicellulosic Sugars (notably arabinose) and lignin.

Lipids are used as structural components to limit water loss and pathogen infection. These lipids include waxes derived from fatty acids, as well as cutin and Suberin. Lipase is an enzyme that hydrolyzes lipids, fatty acids, and acylglycerides, including phosphoglycerides, lipoproteins, diacylglycerols, and the like. Lipases include the following classes of enzymes: triacylglycerol lipase, phospholipase A2, lysophospholipase, acylglycerol lipase, galactolipase, phospholipase A1, dihydrocoumarin lipase, 2-acetyl-1-alkylglycerophosphocholine esterase, phosphatidylinositol deacylase, cutinase, phospholipase C, phospholipase D, 1-hosphatidylinositol phosphodiesterase, and alkylglycerophospho ethanolamine phosphdiesterase. Lipase increases the digestibility of lipids by breaking lipids down digestibly saccharides, disaccharides, and monomers.

Phytate is the main storage form of phosphorous in plants. However, many animals have trouble digesting or are unable to digest enzymes because they lack enzymes that break phytate down. Because phosphorus is an essential element, inorganic phosphorous is usually added to animal feed. Phytase is a hydrolytic enzyme that specifically acts on phytate, breaking it down and releasing organic phosphorous. The term “phytase” means an enzyme that hydrolyzes ester bonds within myo-inositol-hexakisphosphate or phytin. Including 4-phytase, 3-phytase, and 5-phyates. By increasing the activity of the hydrolytic enzymes, organic phosphorous is released and inorganic phosphorous does not have to be added to animal feed.

Protease breaks down proteins and other moieties, such as sugars, into smaller polypeptides and single amino acids by hydrolyzing the peptide bonds. Many of the proteins serve as storage proteins. Some specific types of proteases include cysteine proteases including pepsin, papain and serine proteases including chymotrypsins, carboxypeptidases and metalloen dopeptidases. Proteases play a key role in germinations through the hydrolysis and mobilization of proteins that have accumulated in the seed. Proteases also play a role in programmed cell death, senescence, abscission, fruit ripening, plant growth, and N homeostasis. In response to abiotic and biotic stresses, proteases are involved in nutrient remobilization of leaf and root protein degradation to improve yield.

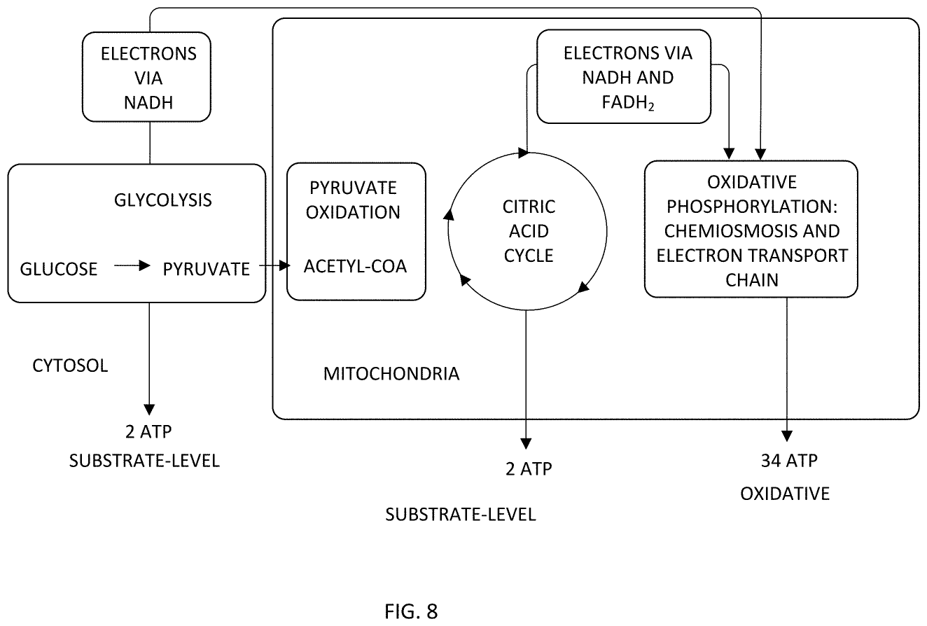

Cellular respiration is a set of metabolic reactions that take place in the cells of the seed to convert chemical energy from oxygen molecules or nutrients into adenosine triphosphate (ATP), as shown in FIG. 8. Nutrients, such as sugar, amino acids and fatty acids are used during cellular respiration. Oxygen is the most common oxidizing agent. Aerobic respiration requires oxygen to create ATP and is the preferred method of pyruvate in the breakdown into glycolysis. The energy transferred is used to break bonds in adenosine diphosphate (ADP) to add a third phosphate group to form ATP by phosphorylation, nicotinamide adenine dinucleotide (NADH) and flavin adenine dinucleotide (FADH₂). NADH and FADH₂ is converted to ATP using the electron transport chain with oxygen and hydrogen being the terminal electron acceptors. Most of the ATP produced during aerobic cellular respiration is made by oxidative phosphorylation. Oxygen releases chemical energy which pumps protons across a membrane creating a chemiosmotic potential to drive ATP synthase.

By decreasing environmental stresses and increasing metabolic activity, the plant can be harvested in an interval that closely aligns with the maximum point of enzyme activity within the plant's life cycle and increased development results. The harvested product is rich in enzymes. Based on enzyme values reported when investigating the malting characteristics of cereals, barley is estimated to have approximately 12,000 kilo novo units (KNO) of amylase activity per kg dry matter, 400 units of protease per milligram protein and 200 units of lipase per milligram protein. Wheat is expected to have amylase levels approximately 50% to 75% the amount of barley on average with lipase and protease values equal and 100% greater, respectively. Enzymes, such as peroxidase and hemicellulose, relating to fiber catabolism are likely also very active due to the decrease in environmental stresses.

For example, barley harvested at the maximum point of enzyme activity, the amount of crude protein increases. Crude protein is the content of the animal feed or plant same that represents the total nitrogen, including true protein and non-protein nitrogen (urea and ammonia). Crude protein is an important indicator of the protein content of a forage crop. In one example the crude protein in barley can be increased by 143% instead of 117% and 125% when harvested on day six, when enzyme activity was maximized. In another example, wheat is harvested at the maximum enzyme point, such as day six, the amount of crude protein can be increased by 129%. The neutral detergent fiber (NDF) of a crop, plant, or feed sample content is a close estimate of the total fiber constituents of the crop. The NDF contains plant cell wall components such as cellulose, hemicellulose, lignin, silica, tannins, and cutins, it does not include some pectins. The structural carbohydrates, hemicellulose, cellulose, and lignin, represent the fibrous bulk of the crop. Though lignin is indigestible, hemicellulose and cellulose can be (in varying degrees) digested by microorganisms in animals with either a rumen, such as cattle, goats or sheep, or hind-gut fermentation such as horses, rabbits, guinea pigs, as part of their digestive tract. NDF is considered to be negatively correlated with dry matter intake, as the percentage of NDF increases the animals consume less of the crop. In one example the NDF in barley can be increased by 178% instead of from 132% and 155% when harvested on day six when enzyme activity is maximized. In another example, when wheat is harvested at the maximum enzyme point, such as day six, the amount ofNDF can be increased by 173%. Water-soluble carbohydrates (WSC) are carbohydrates that can be solubilized and extracted in water. WSC's can include monosaccharides, disaccharides and a few short chain polysaccharides, such as fructans, which are major storage carbohydrates. In one example the WSC in barley increased by 442% instead of from 182% and 191% when harvested on day six when enzyme activity was maximized. In another example, when wheat is harvested at the maximum enzyme point, such as day six, the amount of WSC can be increased by 553%. The increase in percentage is evidence that by increasing the enzyme activity in plants complex storage molecules are being broken down into simpler monomer storage molecules increasing nutrient digestibility. Starch is an intracellular carbohydrate found primarily in the grain, seed, or root portions of a plant as a readily available source of energy. The in crops where GA activity increases the amount of starch present in the feed is reduced. This may be due to the breakdown of starch into simpler sugars, such as glucose and maltose, by the enzymes increasing nutrient digestibility of the feed. When enzyme activity is maximized the amount of starch in barley can be increased by 17% and by 26% in wheat. Dry matter refers to all the plant material excluding water. The nutrient or mineral content of animal feed or plant tissues may be expressed on a dry matter basis or the proportion of the total dry matter in the material. When enzyme activity is maximized the dry matter ratio can increase, such as by 118% in barley and 115% in wheat, instead of by 92% or 95%.

The breakdown of storage molecules into nutrient digestible monomer subunits can increased by leveraging GA in a hydroponic environment. When GA activity is increased in crops, the crude protein content can increase, such as from 15.9% to 20.4% in rye. When ABA activity is increased the crude protein content decreases, for example, from 15.9% to 13.7%. Crude protein content in a crop, plant, or feed sample represents the total amount in nitrogen in the diet, including protein and non-protein nitrogen. The fibrous component of a crop, plant or feed sample content represents the least digestible fiber portion. The least digestible portion includes lignin, cellulose, silica, and insoluble forms of nitrogen. Hemicellulose is not included in the least digestible portion. Crops with a higher acid detergent fiber (ADF) have a lower digestible energy. As the ADF level increases, the digestible energy level decreases. When GA activity is increased, the ADF percentage increases, such as from 9.2% to 12.8% in rye. When ABA activity increases, the ADF percentage decreases, such as from 9.2% to 4.2%. In crops where the GA activity increases the percentage of NDF increases, such as from 21.6% to 27.1% in rye. In crops, where ABA activity increases, the NDF percentage decreases, such as from 21.6% to 15.2% in rye. The ethanol soluble carbohydrates (ESC) of a plant include monosaccharides, such as glucose and fructose, and disaccharides. When GA activity increases the ESC percentage decreases slightly, as energy is needed to grow the plant or crops. In rye the ESC percentage may decrease from 35.3% to 31.7%. In rye the starch percentage decreased from 19.1% to 9.6%. However, when ABA activity increases due to environmental stressors, the amount of starch in the rye increased from 19.1% to 42.2%. Crude fat is an estimate of the total fat content of the crop or feed sample. Crude fat contains true fat (triglycerides), alcohols, waxes, terpense, steroids, pigments, ester, aldehydes, and other lipids. In feed samples where GA activity was increased due to reducing environmental stresses, the amount of crude fat increases. In rye crops the crude fat may increase from 1.39% to 2.78%. Crude fat also increases when ABA activity increases. In rye crops the crude fat percentage may increase from 1 to 1.44%.

The processes and methods of the present disclosure reduce enteric CH₄ production within ruminants. The processes and methods of the present disclosure provide hydroponically sprouted cereal grains as a sustainable and scalable solution to mitigate enteric methane emissions from ruminants. The processes and methods of the present disclosure increase relative concentration of hexoses and thereby influences rates of glycolysis through inclusion of hydroponically sprouted grains to reduce dihydrogen concentrations within the rumen. With reduced dihydrogen concentrations, inputs for methanogenic archaea are reduced thereby reducing the rate of methanogenesis. Feeding grains or elevated levels of complex carbohydrates often decreases ruminal pH as a direct effect of increased acetate production (Russel 1991). Furthermore, reduced acetate to propionate ratios have been directly correlated to increased levels of methane production (Russel 1991). Hydrolysis reactions external to the rumen, e.g., enzymatic hydrolysis of hemicelluloses during germination, improve efficiency of energy utilization, reduce hydrogen dioxide formation, lower the acetate to propionate volatile fatty acid ratio, and reduce enteric methane production.

### Exemplary Methods

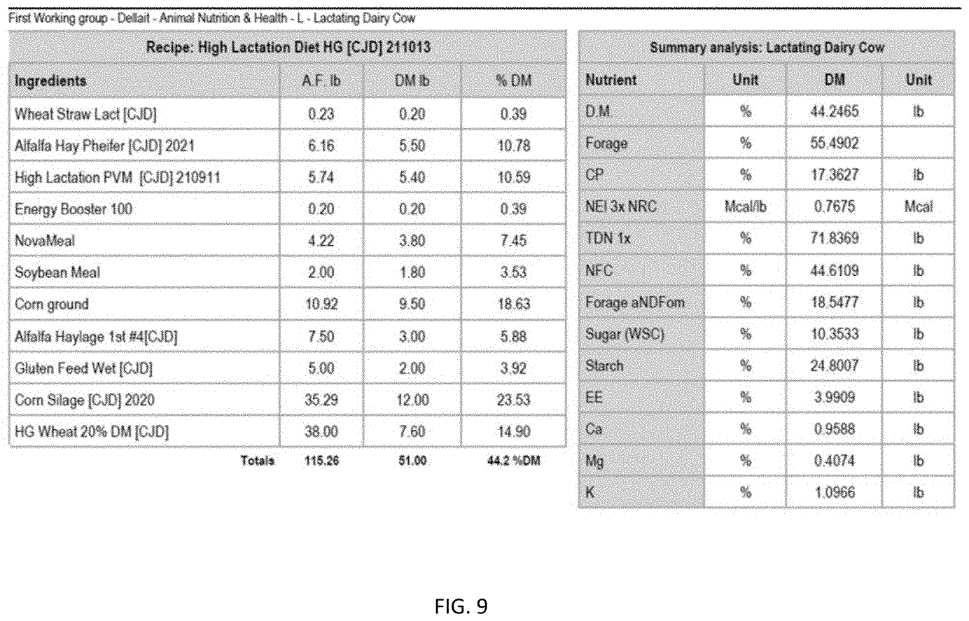

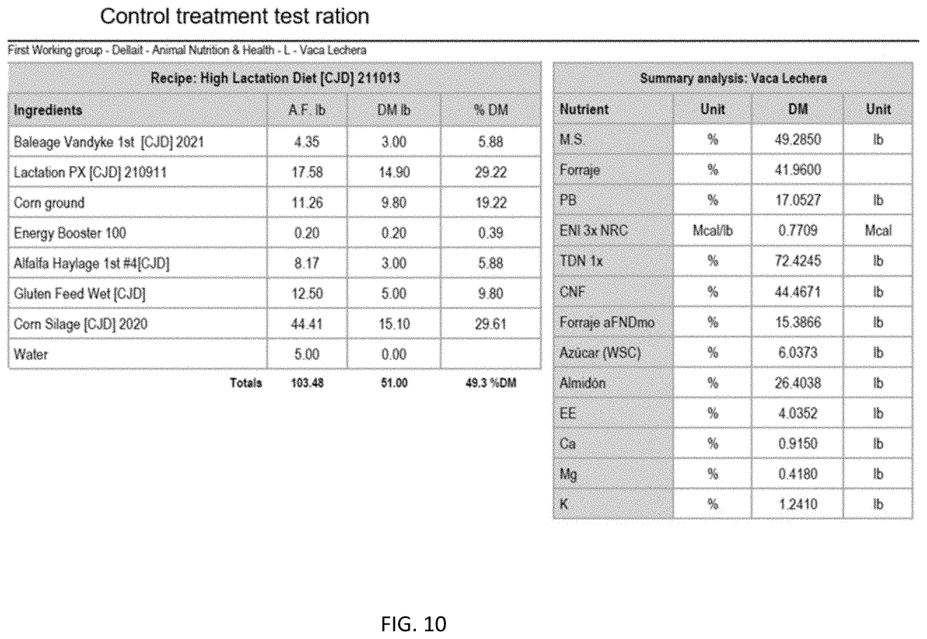

In accordance with at least one aspect of the disclosure, hydroponically sprouted cereal grains as a sustainable and scalable solution to mitigate enteric methane emissions from ruminants provide the methods and processes of the present disclosure. In one aspect, for example, three hundred and forty-six jersey cattle averaging 120 days in milk were investigated in a comparative commercial observation. Two contrasting diets, balanced for crude protein, metabolizable energy, and fat were administered for a nine-week period with hydroponically sprouted cereal grains introduced thereby altering glucose and hexose concentrations (FIGS. 9-10).

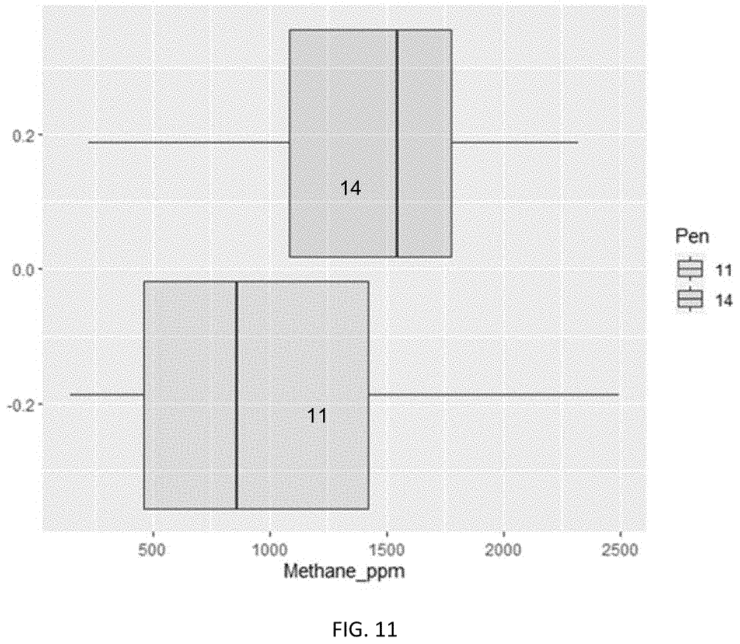

Milk production, milk composition, dry matter intake, feed efficiency, exhaled methane concentration, and production per estimated methane emission were evaluated during the observation. Methane concentration (FIG. 11) was assessed with a hand-held laser gas detector (LMM) (LMm-g®; Tokyo Gas Engineering Solutions, Ltd.) based on infrared absorption spectroscopy using a semiconductor a collimated excitation source and employing the second harmonic detection of wavelength modulation spectroscopy to establish a methane concentration measurement. Utilization of LMM for enteric methane emission quantification has recently been established in the scientific community by multiple researchers (Chagunda et al., 2009; Sorg et al., 2018; Denninger et al., 2020). Measurements for data collection for the observation was adapted from methods outlined in Sorg et al., 2018.

### Exemplary Results

Measurements collected at the nostril closely align with mean values reported in Sorg et al., 2018 for the control treatment (Table 1).

TABLE 1
Methane concentration analysis estimates by sampling location.

| Sampling | | | | | | | |
|---|---|---|---|---|---|---|---|
| Location | HG | Control | SE | df | Contrast | pval | Unit |
| Parlor | 783 | 933 | 4.0 | 10454 | 151 | 0.000 | ppm |
| Nostril | 101 | 125 | 3.2 | 3646 | −24.5 | 0.000 | ppm |
| Manure | 38.13 | 44.48 | 1.08 | 1304 | −6.35 | 0.000 | ppm |

Highly significant reductions in methane concentration were observed from the treatment group in multiple settings across timepoints (Table 2). In one example, treatment ration includes inclusion of hydroponically sprouted grains at 14.9% inclusion. Compared to previously reported studies, the sample size was much larger in this commercial observation (n=71 v. n=10455). Estimated control treatment methane emission and methane emission per unit of milk closely align with previously reported estimates (Knapp et al., 2014; Sorg et al., 2018; Denninger et al., 2020).

TABLE 2
Nutrient composition on a percentage basis of treatment and control rations.
Week 44-47 Methane Analysis

| | Milk | ECM | Fat | Protein | DMI | FE | CH₄¹ | CH₄² | CH₄³ | MCM³* | MECM³** |
|---|---|---|---|---|---|---|---|---|---|---|---|
| Treatment | (lbs) | (lbs) | (%) | (%) | (lbs) | (ECM/DMI) | (g/d) | (g/d) | (g/d) | (g/lbs) | (g/lbs) |
| HydroGreen | 81.1 | 103.7 | 5.16 | 3.69 | 52.7 | 1.97 | 392 | 380 | 386 | 4.76 | 3.72 |
| Control | 78.8 | 99.3 | 5.03 | 3.68 | 54.3 | 1.83 | 451 | 456 | 454 | 5.76 | 4.57 |
| Contrast | 2.3 | 4.4 | 0.13 | 0.01 | −1.5 | 0.14 | −59 | −76 | −68 | 1.00 | 0.85 |
| pval | <0.0001 | <0.0001 | 0.01 | 0.178 | 0.005 | 0.0001 | <0.0001 | <0.0001 | <0.0001 | <0.0001 | <0.0001 |

¹Estimation adopted from Sorg. Et al., 2018 from nostril measurement mean
²Estimation adopted from Wu et al., 2014 from parlor measurement
³Mean of both methods
*Milk lbs/CH₄³;
**ECM lbs/CH₄³

Methane reduction on an energy corrected milk basis were observed to significantly decrease 19% with the inclusion of hydroponically supported grains. Feed efficiency was observed to significantly increase 7.7% with the treatment, and overall production assessed through energy corrected milk production was observed to increase 4.4% from the control treatment.

### Exemplary Discussion

Estimated enteric methane reduction enabled through hydroponically sprouted grains solely meet the estimated reduction needed to meet the International Panel on Climate Control's targets. Compared to currently available methods and processes, the processes and methods of the present disclosure providing the inclusion of hydroponically sprouted grains delivered metabolic energy, increased milk production, and increased feed efficiency of the target group. When the enteric methane reduction potential of hydroponically sprouted grains is coupled with the inherent GHG reduction potential of the processes and methods of the present disclosure, the processes and methods of the present disclosure show extreme potential for independently lowering agricultural related GHG for 2050 targets (Newell et al., 2021). The value of social cost per metric ton of methane has been estimated at $8,290 tonne-1 (Erickson et al., 2021). Using preliminary estimates from the observation, the social cost savings of administering lactation dairy cows hydroponically sprouted grains is approximately $205 year-1 cow-1. Over the estimated 10 million dairy cows in North America, the estimated social savings exceeds $2 billion annually.

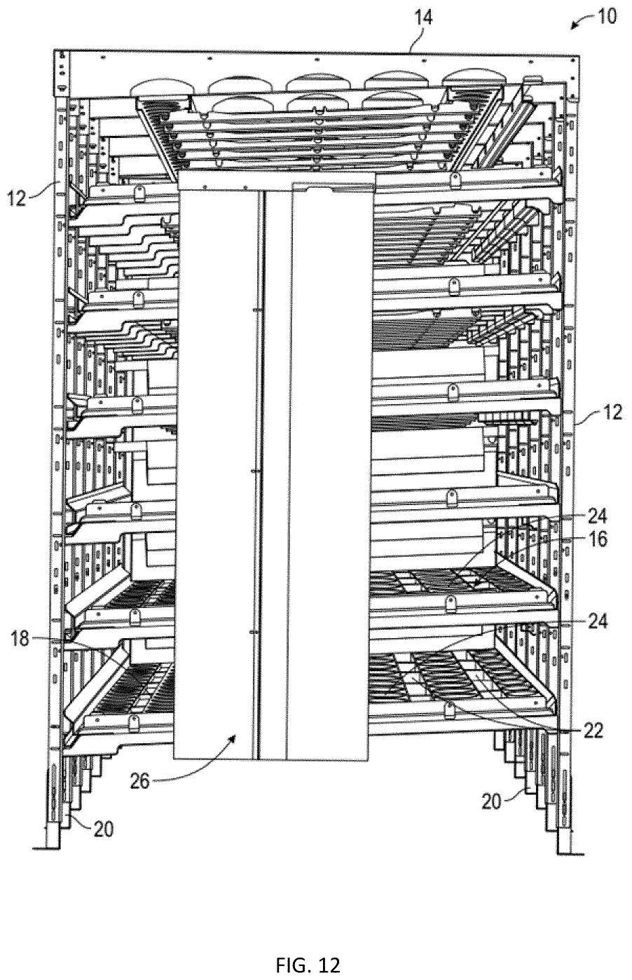

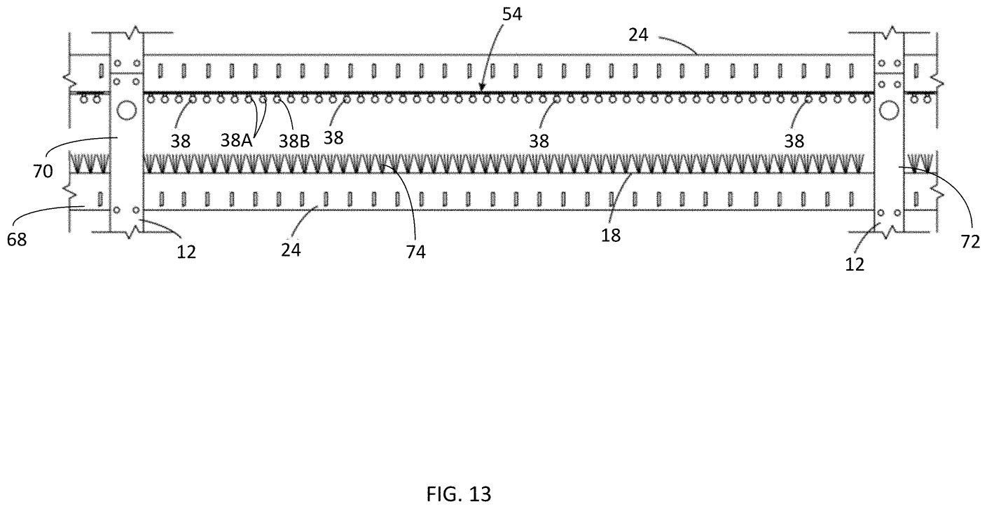

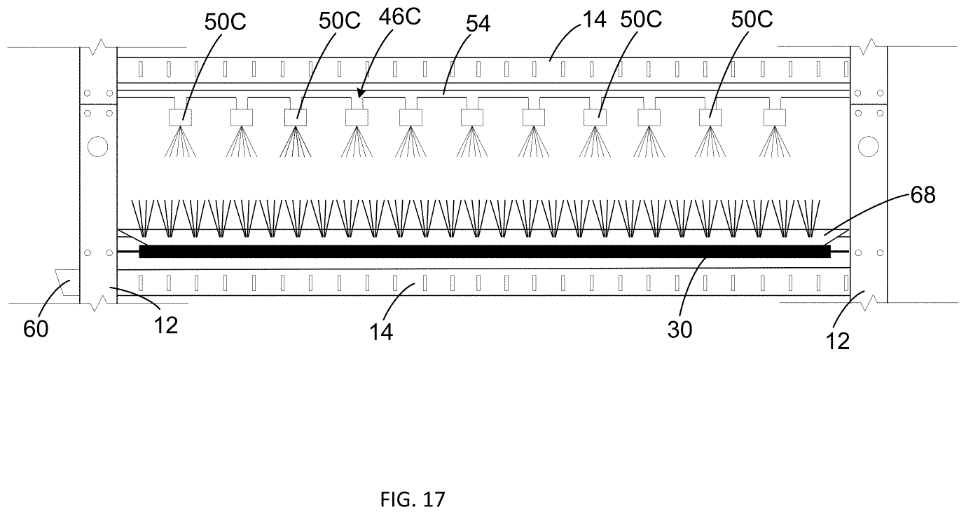

FIG. 12 illustrates a grower system 10. The grower system 10 can provide aerobic conditions allowing the plant to increase dry matter, maximize enzyme activity and increase sugar concentration. The grower system 10, shown in FIGS. 12-18 may include a plurality of vertical members 12 and a plurality of horizontal members 14 removably interconnected to form an upstanding seed growing table 16 with one or more seed beds 18. In some aspects of the present disclosure, the grower system 10 may have one or more seed beds 18. Each vertical member 12 can be configured to terminate at the bottom in an adjustable height foot 20. Each foot 20 can be adjusted to change the relative vertical position or height of one vertical member 12 relative to another vertical number 12 of the seed growing table 16. The horizontal member 14 can be configured to include one or more lateral members removably interconnected with one or more longitudinal members 24. A pair of vertical members 12 may be separated laterally by a lateral member 22 thereby defining the width or depth of the seed growing table 16. Longitudinal members 24 may be removably interconnected with lateral members 22 by one or more connectors 26.

Each seed bed 18 may include a seed belt 28, such as a seed film, operably supported by seed growing table 16. Seed belt 28 can be configured according to the width/depth of seed growing table 16. By way of example, the width/depth of seed belt 28 can be altered according to changes in the width/depth of seed growing table 16. The seed belt 28 material can be hydrophobic, semi-hydrophobic or permeable to liquid. In at least one aspect, a hydrophobic material may be employed to keep liquid atop the seed belt 28. In another aspect, a permeable or semi-permeable material can be employed to allow liquid to pass through the seed belt 28. Advantages and disadvantages of both are discussed herein. Traditional pans use hydrophobic material as part of the seed bed. This may increase water stress as water stays within the seed bed for prolonged periods, creating hypoxic conditions and increasing the concentration of ABA. The seeds use up the available oxygen. In one aspect, seed belt 28 may be discontinuous and may have separate or separated terminal ends. The seed belt 28 may have a length of at least the length of the seed bed 18 and generally a width of the seed bed 18 and may be configured to provide a seed bed for carrying seed. The seed belt 28 may be configured to move across the seed bed 18. Seed belt 28 may also rest upon and slide on top of horizontal members 14. One or more skids or skid plates (not shown) may be disposed between seed belt 28 and horizontal members 14 to allow seed belt 28 to slide atop horizontal members 14 without binding up or getting stuck. The seed bed 18 or seed belt 28 may be positioned at a slope to encourage the drainage of water facilitating an increased oxygenated environment when compared to a pan type fodder set up.

To provide room for expansion the seed belt 28 or seed bed 18 may have a seed egress 68 on one or more sides of the seed bed 18, such as a first side 70 and an opposing second side 72. The seed egress 68 allows room for expansion as the seeds 74 grow, lessening the growth compression of the seeds 74. If the seed bed 18 has walls on the first side 70 or the second side 72, the walls may prevent the seeds 74 from expanding thereby compressing some or all of the seeds. The compressed seeds may receive little to no oxygen resulting in hypoxic or anaerobic conditions. The seed egress 68 may not be covered with seeds during seed out. The empty space allows for expansion as the seed doubles in volume in the first few growth stages, such as in the first 24 hours. If the seeds do not have room to expand, the seed may be subjected to a dense environment with reduced heat, water, and oxygen exchange capabilities.

Each seed bed 18 may include a liquid applicator 46A, 46B, and/or 46C operably configured atop each seed bed 18 for irrigating seed disposed atop each seed bed 18. The seed may be irrigated with water. The dimensions of the seed bed 18 may be configured to accommodate need, desired plant output, or maximization of enzyme activity. Liquid applicator 46A may be configured adjacent at least one longitudinal edge of seed bed 18. Liquid applicator 46A may also be operably configured adjacent at least one lateral edge of seed bed 18. Preferably, liquid applicator 46A may be configured adjacent a longitudinal edge of seed bed 18 to thereby provide drip-flood irrigation to seed bed 18 and seed 74 disposed atop seed bed 18. Liquid applicator 46A may include a liquid guide 48 and liquid distributor 50A, 50B, 50C with a liquid egress 52 having a generally undulated profile, such as a sawtooth or wavy profile generally providing peak (higher elevated) and valley (lower elevated) portions. Liquid applicator 46A can include a liquid line 54 configured to carry liquid 62 from a liquid source 56, such as a liquid collector 58 or plumbed liquid source 56. Liquid 62 may exit liquid line 54 through one or more openings and may be captured upon exiting liquid line 54 by liquid guide 48 and liquid distributor 50A. The one or more openings in liquid line 54 can be configured as liquid drippers, intermittently dripping a known or quantifiable amount of liquid 62 over a set timeframe into liquid guide 48. The one or more openings may be configured intermittently along a length of liquid line 54 or dispersed in groupings along a length of liquid line 54. The one or more openings in liquid line 54 can be operably configured to equally distribute the liquid 62 down the seed bed 18 and slowly drip liquid into the seed bed 18. Drip or flood irrigating the growing surface provides a layer of liquid 62 for soaking the seed and can provide liquid 62 to seed 74 on seed bed 18 in a controlled, even distributive flow. Liquid distributor 50A can be configured with a liquid guide 48 adapted to collect liquid 62 as it exits liquid line 54. Collected liquid may be evenly distributed by liquid distributor 50A and exit the liquid distributor 50A onto the seed bed 18 via the liquid egress 52.

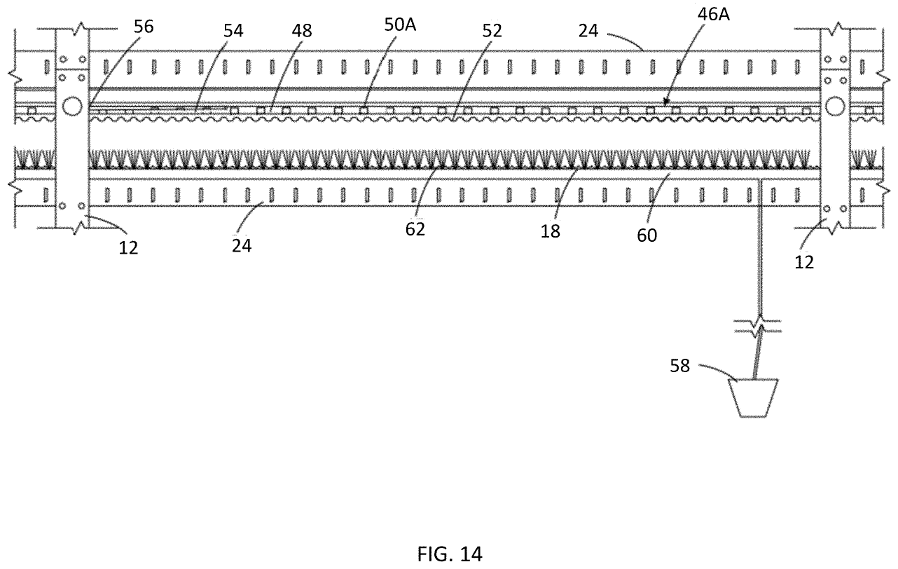

According to at least one aspect, liquid 62 egressing from liquid distributor 50A may travel atop seed belt 28 beneath and/or between a seed mass 74 atop seed belt 28 as shown in FIG. 14. Other configurations of liquid applicator 46 are also contemplated herein. For example, in one aspect, liquid 62 may enter liquid applicator 46 through a liquid line 54 and exit liquid line 54 through a plurality of openings. Liquid 62 from liquid line 54 may coalesce into a small reservoir creating a balanced distribution of liquid 62 across a length of liquid distributor 50A. When this small reservoir becomes full, the liquid 62 may run over and out of liquid egress 52, such as between the teeth of liquid egress 52. In this manner, liquid 62 may be equally distributed down an entire length and across an entire width of the seed bed 18. From liquid egress 52, liquid 62 may drip onto a seed belt 28 where it may run under a bulk of seed on the seed belt 28 to soak or make contact with the seed 74. The root system of seed 74 on the seed belt 28, along with a wicking effect, may move the liquid 62 up through the seed to water all the seeds and/or plants.

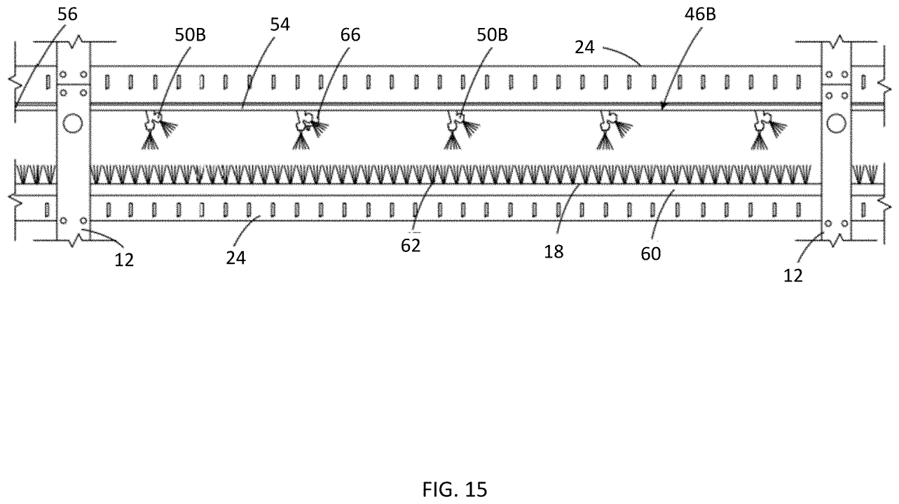

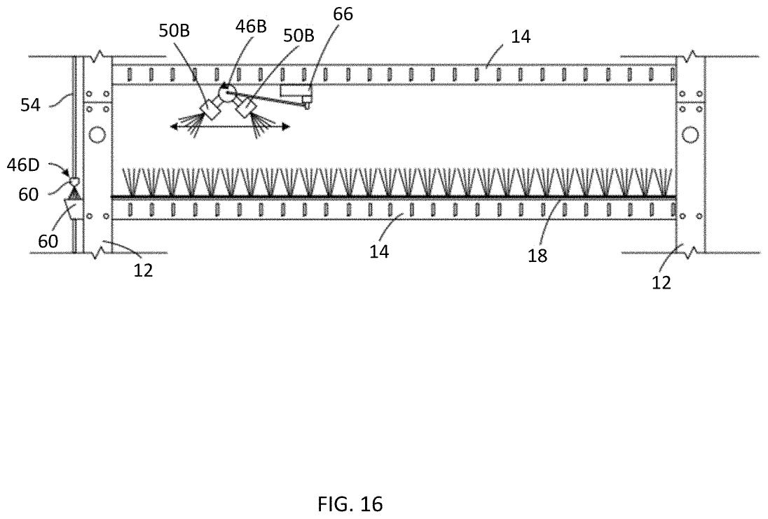

Liquid applicator 46B may be disposed atop each seed bed 18. Liquid applicator 46B may include a plurality of liquid distributors 50B operably configured in a liquid line 54 operably plumbed to a liquid source 56. Liquid distributor 50B can include spray heads, such as single or dual-band spray heads/tips, for spray irrigating seed disposed atop each seed bed 18. In one aspect, a plurality of liquid lines 54 may be disposed in a spaced arrangement atop each seed bed 18. Each liquid line 54 may traverse the length of the holding container and may be plumbed into connection with liquid source 56, as shown in FIG. 15. Other liquid lines 54 can be configured to traverse the width of seed bed 18. Liquid 62 may be discharged from each liquid distributor 50B for spray irrigating seed atop each seed bed 18. In another aspect, each liquid line 54 may be oscillated back and forth over a 10°, 15°, 20°, 25°, 30°, 35°, 40°, 45°, or greater radius of travel for covering the entire surface area of the seed atop each seed bed 18. In the case where dual angle spray heads may be used for liquid distributor 50B, the oscillation travel of each liquid line 54 can be reduced thereby reducing friction and wear and tear on liquid applicator 46B. The process of applying liquid to the seed or plant can be automated by a controller 76, graphical user interface, and/or remote control. A drive mechanism 66 can be operably connected to each liquid line 54 for oscillating or rotating each line through a radius of travel, as shown in FIG. 16. Liquid applicator 46 can be operated manually or automatically using one or more controllers 76 operated by a control system 84.

Liquid applicator 46 may be configured to clean seed bed 18 of debris, contaminants, mold, fungi, bacteria, and other foreign/unwanted materials. Liquid applicator 46 can also be used to irrigate seed 74 with a disinfectant, nutrients, or reactive oxygen species as seed is released onto seed bed 18 from a seed dispenser. A time delay can be used to allow the ROS or nutrients to remain on seed for a desired time before applying or irrigating with fresh water. The process of cleaning, descaling, and disinfecting seed bed 18 using liquid applicator 46D can be automated by a controller 76, graphical user interface, and/or remote control.

Liquid applicator 46 can be operated immediately after seeding of the seed bed 18 to saturate seed with liquid. Seed 74 in early, mid, and late stages of growth can be irrigated with liquid 62 using liquid applicator 46. Liquid applicators 46A-D can be operated simultaneously, intermittently, alternately, and independent of each other. During early stages of seed growth, both liquid applicators 46A-B are operated to best saturate seed to promote sprouting and germination. During later stages of growth, liquid applicator 46A can be used to irrigate more than liquid applicator 46B. Alternatively, liquid applicator 46B can be used to irrigate more than liquid applicator 46A, depending upon saturation level of seed growth. Liquid applicator 46C can be operated during seeding of seed bed 18 and movement of seed bed 18 in the second direction to spray seed dispensed atop seed bed 18 to saturate seed with liquid. The liquid provided to liquid applicators 46A-D could include additives such as disinfectants, reactive oxygen species, fertilizer, and/or nutrients. Nutrients, such as commonly known plant nutrients such as calcium and magnesium, can be added to liquid dispensed from liquid applicators 46A-D to promote growth of healthy plants and/or increase the presence of desired nutrients in harvested seed. Liquid applicators 46C-D can be used also to sanitize seed bed 18 before and/or after winding on or unwinding of the seed belt, the seed bed 18, or seed egress 68 of the seed belt.

Liquid distributors 46A-D and their various components, along with other components of the grower system 10, can be sanitized by including one or more disinfectants, such as reactive oxygen species used by each liquid distributor 50A-D. For example, liquid guide 48, liquid lines 54, liquid egress 52, drain trough 60, liquid collector 58, seed bed 18, liquid distributors 50A-C, and other components of the growing system may be sanitized. In another aspect, liquid applicators 46A-D can be used to clean and sanitize seed bed 18 before, between, or after seeding and harvesting. A separate liquid distributor or manifold can be configured to disinfect or sanitize any components of the growing system that carry liquid for irrigation and cutting or receive irrigation or cutting runoff from the one or more holding containers.

The liquid 62 may be constantly applied, or the applicator may apply the liquid 62 at a set time frame or at a quantifiable amount. For example, the liquid applicator 46A-D may apply the liquid 62 for a first time period such as 1 minute and then the liquid applicator may stop applying the liquid 62 for a second time period, such as 4 minutes, or 1 min of liquid application for every 5 minutes. The cycle may continue until the developmental phase or seed out phase terminates. In another example, the liquid 62 may be applied for 10 min every 2 hours. The liquid applicator 46 may provide a controlled, evenly distributed flow allowing the liquid 62 to reach a maximum number of seeds. Excess liquid 62 may be captured, recycled, and reused by the grower system 10. If the seed bed 18 has an egress or a slant, the slant may aid in the even distribution of the liquid as it egresses through the seed bed 18. In some aspects, the liquid applicator 46 may guide the distribution of the liquid to areas within the seed bed 18, a portion of the seeds 74, or a portion of the plants 74 that need more application. The liquid applicators 46 may also oscillate to cover the larger areas of the seed bed 18 or the entire length and width of the seed bed 18 or seed belt 28.

Each seed bed 18 may include one or more lighting elements 38 or housing lights for illuminating seed atop seed belt 28 to facilitate hydroponic growth of seed or a seed mass atop seed belt 28, as shown in FIG. 15. Lighting elements 38 may be operably positioned directly/indirectly above each seed bed 18. Lighting elements 38 can be turned off and on for each level using a controller 76 or the control system 84. In some aspects, one level of the grower system 10 may have the lighting elements 38 turned on while another level may have the lighting elements turned off. Lighting elements 38 can be powered by an electrochemical source or power storage device, electrical outlet, and/or solar power. In one aspect, lighting elements 38 may be powered with direct current power. Contemplated lighting elements 38 include, for example, halide, sodium, fluorescent, and LED strips/panels/ropes, but are not limited to those expressly provided herein. One or more reflectors (not shown) can be employed to redirect light from a remote source not disposed above each seed bed 18. Lighting elements 38 can be operably controlled by a controller 76, a timer, user interface or remotely. Operation of lighting elements 38 can be triggered by one or more operations of grower 10. For example, operation of a seed belt 28 can trigger operation of lighting elements 38. The process of lighting a seed bed 18 can be automated by controller 76, graphical user interface, and/or remote control. In one aspect, lighting elements 38 may be low heat emission, full ultraviolet (UV) spectrum, light emitting diodes that are cycled off and on with a controller 76, preferably on 18 hours and off 6 hours in a 24-hour period. The lighting elements 38 may emit multiple light frequencies at a specific ratio, such as a 2:1 ratio of R/FR light or the lighting elements may emit different light frequencies. For example, lighting element 38A may emit red light and lighting element 38B may emit white light. The lighting elements may be placed sequentially or in a pattern that permits the proper ration. The controller 76 or control system 84 may control the frequency, intensity, or ratio of the lighting elements 38.

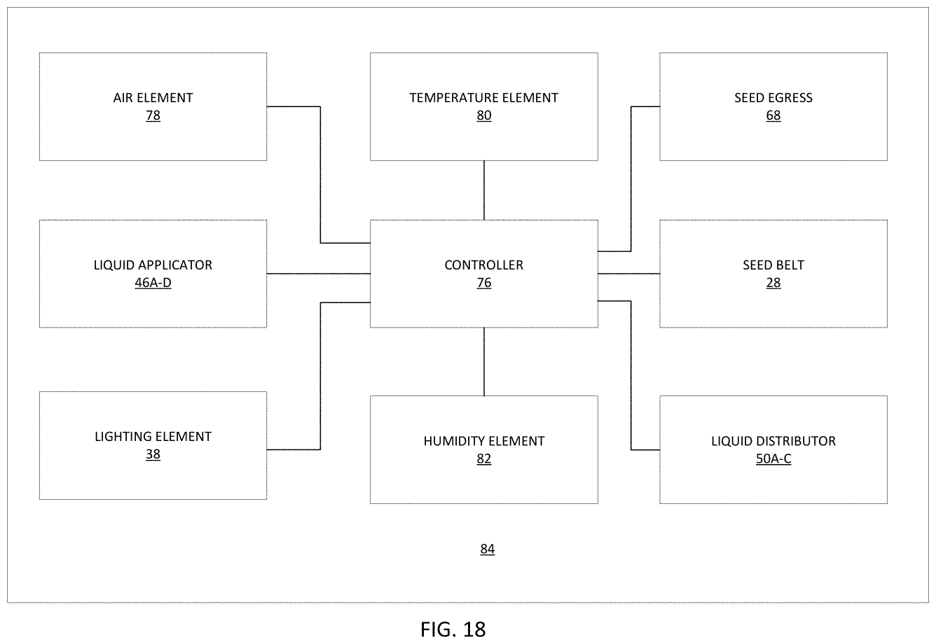

The grower system 10 may have a control system 84 for controlling different environmental conditions or operating conditions of the grower system. The control system 84 may control at least one air element 78 such as a fan or HVAC system to control air movement around the seed bed, as shown in FIG. 18. The air element 78 may be operably connected to the controller 76. A room or environment where the grower system 10 may be stored may also have one or more fans used to control air movement. The air movement or flow may be changed depending on the developmental phase of the seeds on the seed bed. A temperature element 80, such as an HVAC unit, may be operably connected to the grower system 10, controller 76, or the seed bed 18 to control the temperature of the environment of the seed bed 18. The temperature element 80 may maintain temperatures ranging of 65 to 85 degrees F. or 18 to 30 degrees C. A humidity element 82 may be operably connected to the controller 76, growing system 10, or seed bed 18 for controlling the humidity of the environment of the seed bed 18. The humidity unit 82 may maintain a relative humidity level between 50% and 90%. The temperature element 80, air element 78, and humidity element 82 may all include the same HVAC unit. The temperature and air humidity may be changed depending on the developmental phase of the seeds on the seed bed 18. The process of controlling the air movement, temperature, and humidity of a seed bed 18 can be automated by controller 76, graphical user interface, and/or remote control. The lighting, temperature, air flow, and liquid application may all affect the humidity of the seed bed 18.

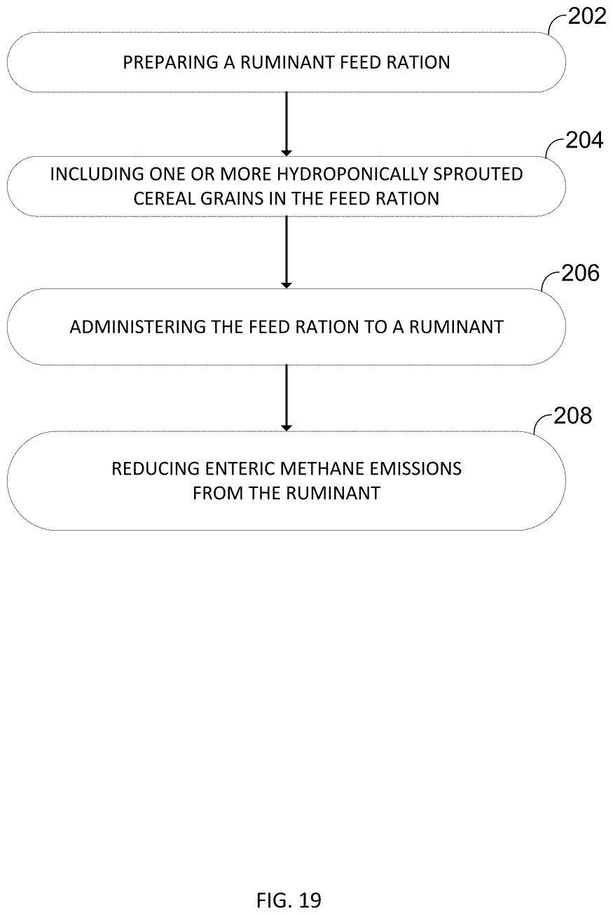

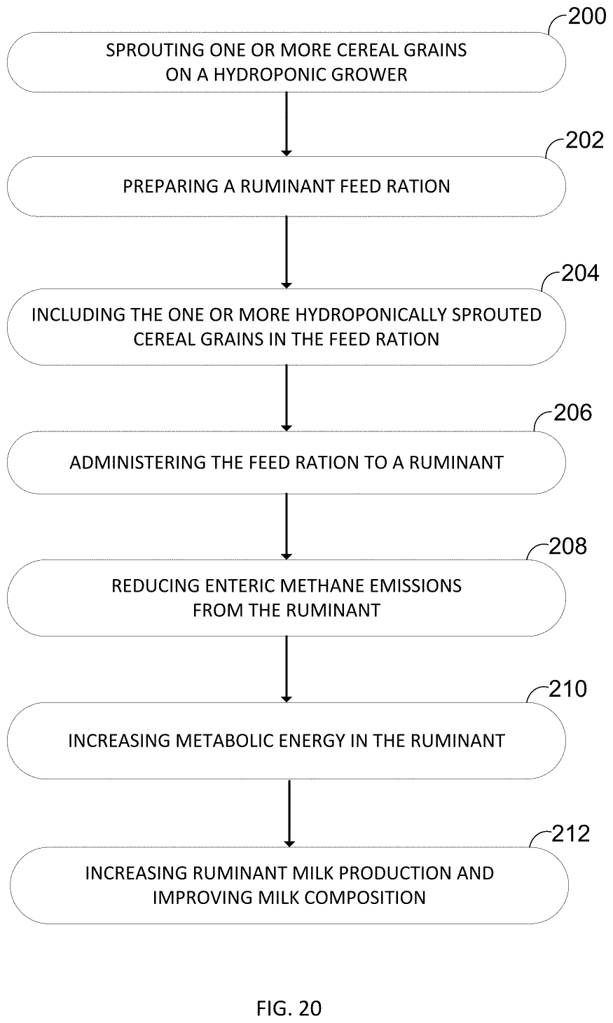

In at least one aspect of the present disclosure a method for reducing enteric methane emissions in ruminants is shown in FIG. 19. The method includes, for example, such steps as preparing a ruminant feed ration (Step 202), including one or more hydroponically sprouted cereal grains in the feed ration (Step 204), administering to a ruminant the feed ration (Step 206) having at least one feed component comprising one or more hydroponically sprouted cereal grains for reducing enteric methane emissions (Step 208). The method can also include steps, such as, for example, increasing concentration of hexoses within the rumen with the feed ration, increasing rates of glycolysis within the rumen with the feed ration, reducing dihydrogen concentrations within the rumen with the feed ration, and increasing metabolic energy in the ruminant with the feed ration. In accordance with at least one exemplary aspect, the one or more inputs for methanogenic archaea are reduced thereby reducing methanogenesis and the methane reduction measurements are on an energy corrected milk basis. In still another exemplary aspect, the method includes steps, such as, increasing milk production and improving milk composition in the ruminant with the feed ration and increasing efficiency of the feed ration having the at least one feed component comprising the one or more hydroponically sprouted cereal grains.

In another aspect of the present disclosure a method for managing methane emission in a ruminant is disclosed. The method includes steps, such as, for example, sprouting one or more cereal grains on a hydroponic grower (Step 200) for preparing a ruminant feed ration (Step 202) by including the one or more hydroponically sprouted cereal grains in the feed ration (Step 204), administering the feed ration to a ruminant (Step 206), reducing enteric methane emissions from the ruminant (Step 208), increasing metabolic energy in the ruminant (Step 210), and increasing ruminant milk production and improving milk composition (Step 212). In other steps discussed and contemplated herein, but not necessarily explicitly enumerated in the figures, the method includes, such as, for example, increasing concentration of hexoses within the rumen with the feed ratio, increasing rates of glycolysis within the rumen with the feed ration, reducing dihydrogen concentrations and lowering the acetate to propionate volatile fatty acid ratio within the rumen with the feed ration, and increasing metabolic energy in the ruminant with the feed ration. In accordance with at least one exemplary aspect, the one or more inputs for methanogenic archaea are reduced thereby reducing methanogenesis. In still another exemplary aspect, the steps include, for example, increasing milk production and improving milk composition in the ruminant with the feed ration. In another exemplary aspect, the method includes, for example, increasing efficiency of the feed ration having the at least one feed component comprising the one or more hydroponically sprouted cereal grains.

The disclosure is not to be limited to the particular aspects described herein. In particular, the disclosure contemplates numerous variations in promoting germination and growth utilizing light signaling in cellulosic material. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes, or methods of the disclosure. It is understood that any other modifications, substitutions, and/or additions can be made, which are within the intended spirit and scope of the disclosure.

What is claimed is:

1. A method for hydroponically sprouted cereal grains as a mechanism for lowering enteric methane emission and improving ruminant feed efficiency and ruminant performance, the method comprising:
administering to a ruminant a feed ration having at least one feed component comprising one or more hydroponically sprouted cereal grains for reducing enteric methane production.

2. The method of claim 1, further comprising:
increasing concentration of hexoses within the rumen with the feed ration.

3. The method of claim 1, further comprising:
increasing rates of glycolysis within the rumen with the feed ration.

4. The method of claim 1, further comprising:
reducing dihydrogen concentrations within the rumen with the feed ration; and
lowering the acetate to propionate volatile fatty acid ratio.

5. The method of claim 1, further comprising:
increasing metabolic energy in the ruminant with the feed ration.

6. The method of claim 1, wherein one or more inputs for methanogenic archaea are reduced thereby reducing methanogenesis.

7. The method of claim 1, wherein the methane reduction measurements are on an energy corrected milk basis.

8. The method of claim 1, further comprising:
increasing milk production and improving milk composition in the ruminant with the feed ration.

9. The method of claim 1, further comprising:
increasing efficiency of the feed ration having the at least one feed component comprising the one or more hydroponically sprouted cereal grains.

10. A method for managing methane emission in a ruminant, the method comprising:
hydroponically sprouting one or more cereal grains for at least one feed component for ruminants;
feeding the ruminant a feed ration having the at least one feed component comprising the one or more hydroponically sprouted cereal grains for reducing enteric methane production.

11. The method of claim 8, further comprising:
increasing concentration of hexoses within the rumen with the feed ration.

12. The method of claim 8, further comprising:
increasing rates of glycolysis within the rumen with the feed ration.

13. The method of claim 8, further comprising:
reducing dihydrogen concentrations within the rumen with the feed ration.

14. The method of claim 8, further comprising:
increasing metabolic energy in the ruminant with the feed ration.

15. The method of claim 8, wherein one or more inputs for methanogenic archaea are reduced thereby reducing methanogenesis.

16. The method of claim 8, further comprising:
increasing milk production and improving milk composition in the ruminant with the feed ration.

17. A system for hydroponically sprouted cereal grains as a mechanism for lowering enteric methane emission and improving ruminant feed efficiency and ruminant performance, the system comprising:
a grower for hydroponically sprouting one or more cereal grains for growing at least one feed component for ruminants;
a feed ration having the at least one feed component comprising the one or more hydroponically sprouted cereal grains for reducing enteric methane production in ruminants.

18. The system of claim 17, wherein the feed ration having the at least one feed component comprising the one or more hydroponically sprouted cereal grains increases metabolic energy in the ruminant with the feed ration.

19. The system of claim 17, wherein the feed ration having the at least one feed component comprising the one or more hydroponically sprouted cereal grains increases milk production and milk composition in the ruminant.

20. The system of claim 17, wherein the feed ration having the at least one feed component comprising the one or more hydroponically sprouted cereal grains increases efficiency of the feed ration.
